(19) United States
(12) Patent Application Publication
(10) Pub. No.: US 2001/0027439 A1
(43) Pub. Date: Oct. 4, 2001

(54) Method and system for computerized form completion

(76) Inventors: Henry N. Holtzman, West Roxbury, MA (US); Craig Wisneski, Cambridge, MA (US); Patricia S. Robertson, Lexington, MA (US); Blaze Stancampiano, Portsmouth, NH (US)

Correspondence Address: TESTA, HURWITZ & THIBEAULT, LLP, HIGH STREET TOWER, 125 HIGH STREET, BOSTON, MA, 02110, US

(21) Appl. No.: 09/726,296

(22) Filed: Nov. 30, 2000

Related U.S. Application Data
(63) Continuation-in-part of application No. 09/539,768, filed on Mar. 31, 2000.
(63) Continuation-in-part of application No. 09/615,452, filed on Jul. 13, 2000.
(63) Continuation-in-part of application No. 09/696,663, filed on Oct. 25, 2000.
(60) Provisional application No. 60/161,392, filed on Oct. 26, 1999.
(60) Provisional application No. 60/190,994, filed on Mar. 21, 2000.
(60) Provisional application No. 60/163,150, filed on Nov. 2, 1999.
(60) Provisional application No. 60/163,311, filed on Nov. 3, 1999.
(60) Provisional application No. 60/164,234, filed on Nov. 8, 1999.
(60) Provisional application No. 60/235,174, filed on Sep. 25, 2000.
(60) Provisional application No. 60/144,145, filed on Jul. 16, 1999.

(51) Int. Cl. G06F 17/60; G06F 17/00; G06K 5/00

(52) U.S. Cl. 705/39; 235/375; 235/380; 705/41

(57) ABSTRACT

A computer-based system and method for completing a form requesting information about the user that is presented to a user in a computer application program. A form presented to a user in a computer application program is identified. A token, which is a magnetic stripe card or a RFID tag is received. The token either has a unique identifier, or information that can be used to generate a unique identifier. The unique identifier is associated with a user. User information is obtained based on the identifier. Elements of user information are matched with elements of requested information about the user requested in the form. The form request for information is completed with the matching elements of user information.

### CROSS-REFERENCE TO RELATED APPLICATIONS

This application claims priority from the following U.S. provisional patent applications, which are incorporated herein by reference:

Ser. No. 60/161,392, filed Oct. 26, 1999 (Attorney Docket No. PRT-004PR)

Ser. No. 60/190,994, filed Mar. 21, 2000 (Attorney Docket No. PRT-004PR2)

Ser. No. 60/163,150, filed Nov. 2, 1999 (Attorney Docket No. PRT-006PR)

Ser. No. 60/163,311, filed Nov. 3, 1999 (Attorney Docket No. PRT-7PR)

Ser. No. 60/164,234, filed Nov. 8, 1999 (Attorney Docket No. PRT-008PR)

Ser. No. 60/235,174, filed Sep. 25, 2000 (Attorney Docket No. PRT-009PR)

This application claims priority to co-pending application Ser. No. 09/539,768 titled “Wireless Transceiver For Communication With Tags”, filed Mar. 31, 2000, Attorney Docket No. PRT-001, assigned to the assignee of the present invention (and incorporated herein by reference). This application also claims priority to co-pending application Ser. No. 09/615,452 filed Jul. 13, 2000 (Attorney Docket No. PRT-003), which claims priority to U.S. Provisional Patent Application Ser. No. 60/144,145, filed Jul. 16, 1999 (Attorney Docket No. PRT-003PR). This application also claims priority to co-pending application Ser. No. 09/696,663, filed Oct. 25, 2000 (Attorney Docket No. PRT-004).

### TECHNICAL FIELD

The present invention relates to computer networks, and in particular to a method and apparatus for completing computerized forms.

### BACKGROUND INFORMATION

Computer users accessing web sites over the Internet are frequently presented with forms that require completion. These forms are often tedious to fill out, and require duplication of effort each time a user wishes to interact with a site. Often the same information, such as the user's contact information, is requested by each web site.

Some web sites require a user to provide a username and password each time the web site is accessed. It can be difficult for users to remember the different usernames and passwords that the user has for each web site. If a user writes down the usernames and password, there is risk that someone else will see that information. Also, if the user is not always at the same location, storage of the list of usernames and passwords can be problematic.

### SUMMARY OF THE INVENTION

A secure system that facilitates the completion of on line forms allows users to easily respond to on-line information requests. The user's information is stored, either locally or on a network, and a computer program interfaces with the user's network application to provide the requested information. The user's information is obtained in response to a hardware token such as a radio frequency identification (RFID) tag and a magnetic stripe card. Some of the user's information may be stored on the token, for example, recorded on the magnetic stripe.

Generally, in one aspect, the invention relates to a computer-based system and method that automatically completes a form requesting information about the user that is presented to a user in a computer application program. A form presented to a user in a computer application program is identified. A token, which in various embodiments is a magnetic stripe card or a RFID tag, is received. The token either has a unique identifier, or information that can be used to generate a unique identifier. The unique identifier is associated with a user. User information is obtained based on the identifier. Elements of user information are matched with elements of requested information about the user requested in the form. The form request for information is completed with the matching elements of user information.

Generally, in another aspect, the invention relates to a computer-based method for completing a form presented to a user in a computer application program, the form requesting information about the user. The method includes identifying a form presented to a user in a computer application program, the form requesting information about the user. A magnetic stripe card having card information is received. A unique identifier is generated based on the card information. The unique identifier is associated with the user. User information based on the identifier is obtained. Elements of user information are matched with elements of information about the user requested in the form. The form request for information with the matching elements of user information is completed.

In one embodiment, the method steps are performed in response to a single user action of the user directing a magnetic stripe card through a magnetic stripe reader. In another embodiment, the form is identified by parsing the HTML code of a web page. In another embodiment, the magnetic stripe card is received by a reader comprising a magnetic stripe card reader and an RFID token reader. In another embodiment, the unique identifier is generated by providing the card information as input to a one-way function. In one such embodiment, the unique identifier is generated by combining elements of card information, and providing the combined card information as input to a one-way function.

In yet another embodiment, the user information is at least a portion of a user profile obtained from a server accessible via the internet. In another embodiment, the user information is obtained from a local database. In another embodiment, the elements of user information are matched with elements of information about the user requested in the form by using a field mapping script. In another embodiment, elements of user information are matched with elements of information about the user requested in the form by matching form field names with elements of user information. In another embodiment, elements of card information are used to complete the form. In one such embodiment, at least one element of card information as well as matching elements of user information are used to complete the form request.

In another embodiment, a form is identified in a web page downloaded from a merchant web server presented to a user in a web browser. The unique identifier is associated with the user by an information server separate from the merchant web server. The merchant web server obtains user information based on the identifier directly from the information server. The merchant web server completes the form request by matching elements of user information with the requested information.

Generally, in another aspect, the invention relates to a computer-based method for completing a form presented to a user in a computer application program, the form requesting information about the user. A form presented to a user in a computer application program is identified. A magnetic stripe card comprising a unique identifier is received. The unique identifier is associated with the user. User information based on the identifier is obtained. Elements of user information are matched with elements of information about the user requested in the form. The form request for information with the matching elements of user information is completed.

Generally, in another aspect, the invention relates to a computer-based method for completing a form presented to a user in a computer application program. The method includes identifying a form presented to a user in a computer application program, and receiving an RFID tag comprising a unique identifier. The unique identifier is associated with the user. User information based on the identifier is obtained. Elements of user information are matched with elements of information about the user requested in the form. The form request for information with the matching elements of user information is completed.

In one embodiment the method steps are performed in response to a single user action of providing a RFID token to a reader. In another embodiment, the form is identified by parsing the HTML code of a web page. In another embodiment, the magnetic stripe card is received by a reader comprising a magnetic stripe card reader and an RFID token reader. In another embodiment, the user information is at least a portion of a user profile obtained from a server accessible via the internet. In another embodiment, the user information is obtained from a local database. In another embodiment, elements of user information are matched with elements of information about the user requested in the form by using a field mapping script. In another embodiment, elements of user information are matched with elements of information about the user requested in the form by matching form field names with elements of user information.

In another embodiment, a form is identified in a web page downloaded from a merchant web server presented to a user in a web browser. The unique identifier is associated with the user by an information server separate from the merchant web server. The merchant web server obtains user information based on the identifier directly from the information server. The merchant web server completes the form request by matching elements of user information with the requested information. The merchant web server thus completes the form request without user interaction.

Generally, in another aspect, the invention relates to a system for completing a form presented to a user in a computer application program includes a display for displaying a form presented to a user of a computer application program, the form requesting information about the user. The system includes a token reader for receiving a token presented by the customer, the token comprising at least one token of a magnetic stripe card and an RFID tag. The system includes a dispatch module for associating the identifier with the user, obtaining user information based on the identifier, matching elements of user information with elements of information about the user requested in the form, and completing the form request for information with the matching elements of user information.

The foregoing and other objects, aspects, features, and advantages of the invention will become more apparent from the following description and from the claims.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 schematically illustrates an embodiment of a system according to an embodiment of the invention.

FIG. 2 is another embodiment of a system according to the invention.

FIG. 3 is a flowchart depicting an embodiment of a method in accordance with the invention.

FIG. 4 schematically illustrates another embodiment of a system in accordance with the invention.

FIG. 5 is another embodiment a system in accordance with the invention.

FIG. 6 is a more detailed schematic of one embodiment of the invention.

FIG. 7 is an embodiment of a server system according to the invention.

FIG. 8 is an embodiment of a system including a home computer, a retail point of sale and a retail kiosk.

### DETAILED DESCRIPTION

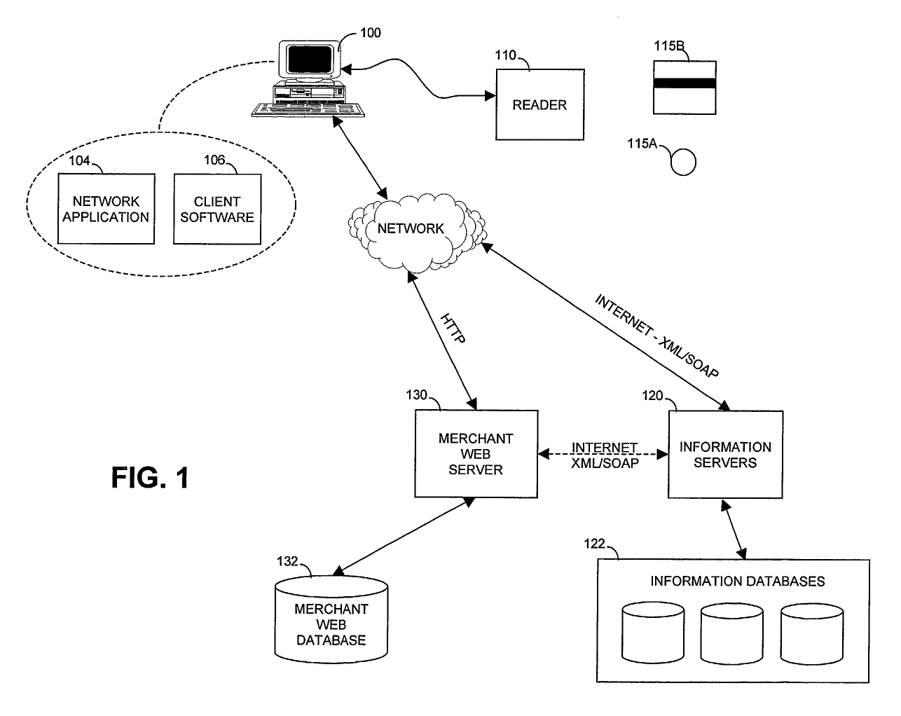

Referring to FIG. 1, a computer 100 is used by a user to connect to a network, such as the Internet or a local area network (LAN). The computer 100 can be a standard personal computer, including a processor from INTEL CORPORATION of Santa Clara, California, RAM and ROM memory, static storage such as a hard disk and floppy disk, and network interface (such as a modem or ethernet card) for providing access to a data network such as the Internet. In some other embodiments the computer is a portable computer, or a public computer, such as a computer in the casing of a retail kiosk at a retail location.

The software running on the computer 100 includes an operating system, for example an operating system such as WINDOWS 98 or WINDOWS NT from MICROSOFT CORPORATION of Redmond, Wash., or GNU/LINUX, such as the version available from RED HAT, INC. of Durham, N.C., among others. Software applications run in coordination with the operating system. In one embodiment, the software applications include one or more network applications 104 and client software 106. The network application is a software application such as a web browser that can display information accessed over a network such as the Internet to a user of computer 100. If the network application 104 is a web browser, the web browser can be controlled by a user to display web pages and other information accessed by the web browser using the Hypertext Transfer Protocol (HTTP) and other protocols. Extensions to web browsers allow for the access of many different types of audio, video, graphics, and text information. Examples of web browsers are INTERNET EXPLORER by MICROSOFT CORPORATION and NAVIGATOR by NETSCAPE COMMUNICATIONS CORPORATION of Mountain View, Calif.

Web server 130 is a web server that provides web pages over the Internet in response to HTTP requests. A web browser or other network application 104 running on computer 100 can connect to the web server 130 and request web pages. The user (via the browser) can issue requests, such as viewing a new page or modifying page information, or submit information, such as a username and password for purposes of user authentication, or a description of an item desired for purchase, via the browser interaction with the web server 130. The web server 130 can provide web pages associated with a merchant of goods or services. The web pages provided by the merchant's web server are related to the goods or services provided by the merchant. The web pages can include pages providing information about the goods and services offered by the merchant, web pages for ordering goods or services, web pages for checking the status of an order, or the progress of services, and so on.

In one embodiment, a user (not shown) presents a token, generally 115, which has a unique identifier, to a token reader 110. The token reader is in communication with the computer 100. In one embodiment, the token is a radio frequency identification (RFID) tag 115A. In another embodiment, the token is a magnetic stripe card 115B. The reader 110 can read data from magnetic stripes, RFID tokens, or both. The personal computer 100 communicates with the reader 110 using a standard interface, such as serial, parallel, universal serial bus (“USB”) and so on.

To read RFID tags, reader 110 emits a radio signal. If a token such as RFID tag 115A is within range of the radio signal, the tag 115A will respond by providing its identifier, and possibly other information, to reader 110. In some implementations, the identifier is a 32 bit serial number assigned at time of manufacture and unique to that tag. Although the term “RFID” is an abbreviation of radio-frequency identification, it has attained a more generic connotation in the art. Accordingly, as used herein, the term “RFID” broadly connotes any system utilizing a wirelessly readable signature or code embedded into a minuscule package, typically a chip that can be incorporated within an article. The term “token” includes not only small items, such as easily carried cards or “poker chip” disks, intended solely as housings for the RFID tag, but also more commonplace articles, such as key chains or key tags, product containers, watches, jewelry, personal effects, and even credit cards or card form factors- that incorporate the RFID tag. The typical RFID tag is small, low-power microchip combined with an antenna. Reader 110 transmits the excitation signal that is received by the microchip (via the antenna), which uses the signal both as a source of power and as means of imparting information back to reader 110. RFID Tags are made by companies including Royal Philips Electronics N.V. of Sunnyvale, Calif., Texas Instruments, Inc. of Dallas, Tex., and Motorola, Inc. of Schaumburg, Ill.

To read magnetic swipes, the reader 110 contains magnetic stripe reading electronics. The magnetic stripe reading electronics of the reader can be supplied by original equipment manufacturers such as Mag-Tek, Inc. of Carson, Calif. or SEMTEK INNOVATIVE SOLUTIONS CORPORATION of San Diego, Calif. for integration into Reader 110. The magnetic stripe swiped can be on a traditional credit card, loyalty card, or other card or object with a magnetic stripe. Often, the magnetic stripe reader 110 will read one or more of the tracks of information on the magnetic stripe card 115B. In the case of a credit card, the magnetic stripe card 115B will have a magnetic stripe with up to three tracks of information. In one implementation, Reader 110 will read the data contained in both Track 1 and Track 2, and use a combination or permutation of that information as a unique identifier. To create a unique identifier, elements of the information on the credit card magnetic stripe can be combined together, and be provided as input to a function to create a unique, identifying number for that particular credit card. In one implementation, this can be a unique one-way function. In one implementation, the execution of a one-way function on the content read from the magnetic stripe takes place on reader 110. In another implementation, the information on the magnetic stripe card 115B is passed to software resident on computer 100 for processing.

The personal computer 100 includes client software 106, which communicates with reader 110 information about the token 115 that is presented to the reader 110. In one embodiment, the information provided to the client software by the reader 110 is a unique identifier associated with a token 115. In another embodiment, the client software derives a unique identifier from information received from the reader 110.

In one embodiment, a one-way, or “hash” function takes as input a message of arbitrary length and produces a 128-bit message digest. The hash function creates a numeric representation of the contents of a message and outputs the result as a 16 character hexadecimal value. Theoretically, a 128-bit message digest has 2ˆ 128 possible hash values. With a good one-way function, it is infeasible for anyone to either find a message that results in a given value or to find two messages that result in the same value, meaning that it would not be feasible for someone to determine the card information that was used to generate the one-way function output.

In one embodiment, input messages to the algorithm are taken from tracks of data on the magnetic stripe card. For instance, a cardholder's name and card number can be read from the card, and used as input messages to the one-way function. The output of the one-way function is a 128-bit message. The same input information (e.g. name and card number) when presented as input to the one-way function in the same way produces the same 128-bit output. If the input information varies, a different 128-bit message results.

In one embodiment, a user registers a credit card by swiping a credit card bearing a magnetic stripe through the reader 110. The client software 106 collects the credit card data, and queries the user about which types of services should be allowed to access credit card data, and what passwords should be used in conjunction with the card (if any). Services referenced here include actions like form-fill or login with web site username and password. Services might act on all web sites, or be limited to particular web sites or applications.

The system then creates strings for each service, that are a combination of the credit card information, a user password, and a service identifier that identifies the service. The combination can be a concatenation, a logical operation on the values (for example AND, OR, XOR), or the result of input values to another function, such as an encryption algorithm or one-way function. Once the combined string is created, the client software then creates index strings using a one-way function.

In one embodiment, the one-way function is SHA described in the Secure Hash Standard of the National Institute of Standards and Technology NIST FIPS PUB 180-1, “Secure Hash Standard” United States Department of Commerce, Apr. 17, 1995. Other one-way functions that can be used are MD5, described in Internet Engineering Task Force RFC 1321 by R. L. Rivest, April 1992, and RIPEMD-160, described in H. Dobbertin, A. Bosselaers and B. Preneel, “RIPEMD-160: A Strengthened Version of RIPEMD,” pages 71-82 of D. Gollmann, Ed., Fast Software Encryption, Lecture Notes in Computer Science 1039, Springer-Verlag, 1996.

When the user swipes a credit card bearing a magnetic stripe through a reader connected to a computer with the client software. If specified by the user, the system queries the user for a password. Depending on which service the user is attempting to access, the client software creates a service string that is a combination of the credit card information, a user password, and a service identifier that identifies the service. That service string is provided as input to the one-way function to generate and index string. The index string is then used to retrieve data from the table. If the password provided is not correct, or if the service string was not one of the selected services upon registration, the table access will fail.

The client software 106 on the computer 100 communicates with the reader 110, network application(s) 104, and information servers 120, which are described further below. The client software 106 can store data on the local static storage (e.g. hard disk) of the computer 100 in the form of a data file or local database.

Communication with the information servers 120 is accomplished through client/server communication over a computer network. This network communication can be accomplished through standard Internet protocols, such as hypertext transfer protocol (HTTP). In one embodiment, information is passed through an extensible markup language (XML) based protocol called the Simple Object Access Protocol, or SOAP. SOAP messages can be carried in HTTP messages.

The client software 106 accesses user data based on the token's 115 unique identifier. The unique identifier acts as a key to reference a profile, which is a set of information related to a user. The information in the profile can include identifying information such as the user's name, address, and contact information (home address, telephone numbers, electronic mail address, and so on). The profile can also contain information that specifies accounts with specific merchants, such as user-names and passwords for specific websites. In addition, the profile can include a user's preferences for payment, and include loyalty/rewards point totals, store discount offers, and coupons. The user profile can be stored in the computer 100, or on information servers 120 accessible over a computer network such as the Internet.

In one implementation, the client software 106 running on the computer 100 receives a unique identifier from the reader 110 and queries the local profile storage. If the unique identifier is associated with a locally stored profile, the profile is obtained for use by computer 100. If no record is found locally, or if the information in the computer 100 is determined to be out of date, client software 106 initiates a lookup for such a profile on information servers 120, using the unique identifier.

The information returned to computer 100 can include some portion or the entire contents of a profile associated with the unique identifier. In one implementation, the client software 106 specifies exactly what information is needed from the information servers 120. For example, in one implementation, the client software 106 determines that it needs to receive a user's name, address, and phone number from the profile accessed via servers 120. In one embodiment, profile information accessed by the servers 120 is stored in databases 122.

In another implementation, servers 120 determine, based on the request, the appropriate information to return. This determination could be based at least in part on the location of the request, with identification information provided by the computer 100 enabling a determination by the server 120 of the request location. Such identification information can include a unique identification number of the reader 110. In one embodiment, the information servers 120 are configured to only respond with a user's information (such as a name, address, and phone number) when the request comes from a computer 100 with a specific reader 110 that is located in a user's home.

As an example of the system in operation, a user viewing a web page provided by merchant web server 130 with a network application 104 is prompted to enter a username and password. The web page includes a form with places for the user to enter the username and password, and a button labeled “submit” for submitting the username and password information to the merchant web server 130. Instead of typing the username and password, the user presents a token 115 to the reader 110 and initiates information lookup based on the unique identifier associated with the token 115.

In this example, the client software 106 receives the unique identifier of the token 115, and recognizes that network application 104 is displaying a form request for a username and password. The client software 106 formulates a query to information servers 120 requesting a username and password combination for the appropriate web site from the user's profile, which is specified by the unique identifier. The information servers 120 obtain from the information databases 122 the profile associated with the unique identifier, and identify the appropriate information in the profile. The information is returned to the client software 106. The client software 106 then “fills in” the requested information on the web page.

In one embodiment, the form is filled in, and the user can check to see if the information is correct, and then click the “submit” button. In another embodiment, the client software 106 both fills in the username and password and causes the network application 104 to submit the information to the merchant web server 130.

In another embodiment, when the request for information is made to servers 120, the servers 120 can respond with the appropriate information directly to the merchant web server 130. This communication can occur over an optional HTTP or XML protocol link between the servers 120 and the merchant web server 130. The merchant web server can formulate an appropriate response and instruct the information servers 120 to pass that response back to the client software 106. That response could be, for example, the uniform resource locator (URL) web address of another web page, and the client software 106 instructs the network application 104 to use that URL, thereby completing the request.

In an illustrative example of one such embodiment, a user interacts with a web site whose merchant web server 130 maintains a connection, and has an established relationship with information servers 120. The user, when viewing a web page served by the merchant web server 130, is presented with a form for completion by the user. Instead of typing information into the form, the user presents a token 115 with a unique identifier to the reader 110.

The client software 106 sends the unique identifier to the information servers 120, along with other information such as the URL of the site, and a transaction or session identifier generated by the merchant web server 130 and included in the web page served by the merchant web server 130. The information servers 120 receive this information and, based on the unique identifier, perform a lookup in the information databases 122 to obtain the user's information, such as payment information, shipping information, and so on. The information servers 120 authorize and clear the transaction through a third-party payment processor (not shown) such as an existing check or credit card authorization and clearance network. The information servers 120 then pass an authorization or clearance code directly to the merchant web server 130, along with information that identifies the user and session ID that resulted in the authorization. The information servers 120 can also provide the merchant web servers 130 with shipping information that can be used to fulfill the order.

Having received the information from the information servers 120 about the identity of the user, and possibly even that the payment amount has been cleared, the merchant web server can clear the transaction. The merchant web server 130 generates a web page for the user to see that confirms the purchase. The merchant web server 130 passes the web address (URL) to the information servers 120 with a session ID that allows the servers 120 to distinguish which user to direct to that URL. The information servers 120 communicate with the client software 106 running on the user's computer 100, and the user's web browser is directed to request the confirmation web page. The user is thus presented with a confirmation screen for the purchase.

As another example, the relationship between the merchant web server and the information servers 120 can also be used to allow a user to identify herself to a merchant web server 130 even if there is no form web page presented. The user, when viewing a web page served by the merchant web server 130, which may or may not be a web page requesting a username and password (or other identifying information) presents a token 115 with a unique identifier to the reader 110. The client software 106 sends the unique identifier to the information servers 120, along with other information such as the URL of the site, and a transaction or session identifier generated by the merchant web server 130 and included in the web page served by the merchant web server 130. The information servers 120 receive this information and, based on the unique identifier, perform a lookup in the information databases 122 to obtain the user's information, such as user-name and password. The information servers 120 then pass the user-name and password (optionally, encrypted), or an authorization or clearance code directly to the merchant web server 130, along with information that identifies the user and session ID that resulted in the authorization. The information servers 120 can also provide the merchant web servers 130 with other information about the user. The user may not have a prior relationship with the merchant associated with the merchant web server 130, but the relationship of the user with the information servers is sufficient to authenticate the user to the merchant.

The merchant web server 130 may generates a web page for the user to see that confirms the purchase, and communicate the web address (URL) to the information servers 120 with a session ID that allows the information servers 120 to distinguish which user to direct to that URL. The information servers 120 communicate with the client software 106 running on the user's computer 100, and the user's web browser is directed to request the confirmation web page. The user is thus presented with a confirmation screen for the authentication. Alternatively, the merchant web servers 130 may indicate confirmation on the next web page requested by the user.

Thus, using the Applicant's system, forms presented on-line can be automatically filled with the appropriate information, users can identify themselves to web merchants, and payment transactions can be completed. An online transaction process can also include other opportunities for additional value to the user because loyalty programs, rewards benefits, and affiliate (or referral) information can also be maintained and provided. For example, a user's loyalty and reward points can automatically be accessed and updated through the system.

The system can also facilitate the access to and redemption of discounts, or coupons. Personalized promotions or product discounts can be stored as part of a profile. For example, in one implementation, when a customer visits a product website, merchant coupons are loaded into the customer's profile in a database, accessible through the system's Information Servers. Stored coupons are then automatically redeemed when the payment system is used.

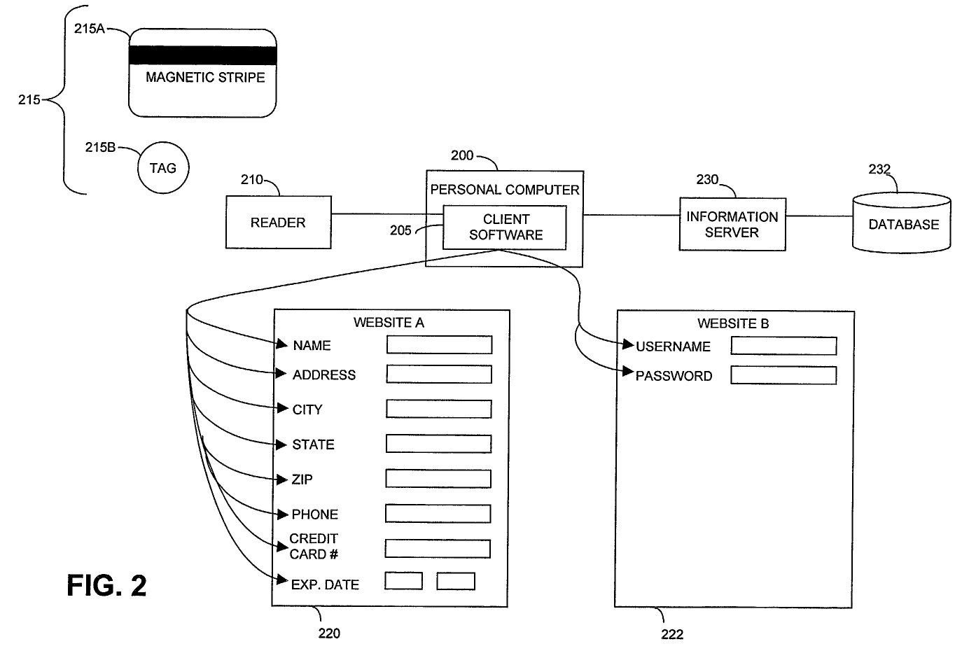

Referring to FIG. 2, in one embodiment, a user has a combined Magnetic Stripe/RFID Reader 210 and the associated client software 205 present on her personal computer 200, which also has a connection to the Internet. The computer 200 has web browser software that allows the user to view and transact with web sites. During the course of using various merchant websites, a user might encounter a website requesting a form to be filled in with user-supplied information. When making a purchase of an item on a first web site 220, a web page displays a form asking the user to submit information about herself, such as her name, address, and phone number, and a method for payment, such as a credit card number and expiration date. When the user visits another web site 222, she is prompted to enter a username and password in order to login, or identify herself to the site. In both cases, the user can enter the information manually through using a keyboard and mouse to type in the information. Alternatively, the user can employ the system described here to complete the forms.

In one embodiment, to have the computer 200 complete a form with the user's personal information, the user swipes a magnetic stripe 215B card through the reader 210. In another embodiment, the user presents an RFID tag 215A to the reader 210. The magnetic stripe card swiped can be on a traditional credit card, or some other kind of card or object with a magnetic stripe. The RFID tag can be an RFID tag embedded within a variety of objects, such as a credit card or card form factor, a key tag, watch, jewelry, personal effects, etc. By presenting either token 215, a unique identifier is obtained by the client software 205. The client software 205 uses that unique identifier to obtain information about the user from the information server 230. The user information is stored in a database 232, and is accessible through information server 230. The client software 205 obtains from the information server 230 the information necessary to fill in the form on the web site 220, 222.

The client software parses the requested information on the web page 220, 222 to determine what information is needed to complete the forms. The client software formulates a query to information server 230 to obtain the necessary information. Once the information is obtained, the client software 205 has the information entered into the forms in the web browser. The resulting user experience is that the presentation of a token causes the forms on the web page to be filled with the appropriate personal information.

In one embodiment, the client software takes different actions based on the token used. For example, if a credit card swipe is made by a same user, but with a different credit card than is usually used, the system uses that user's information but uses the credit card number and expiration date of the credit card that was swiped.

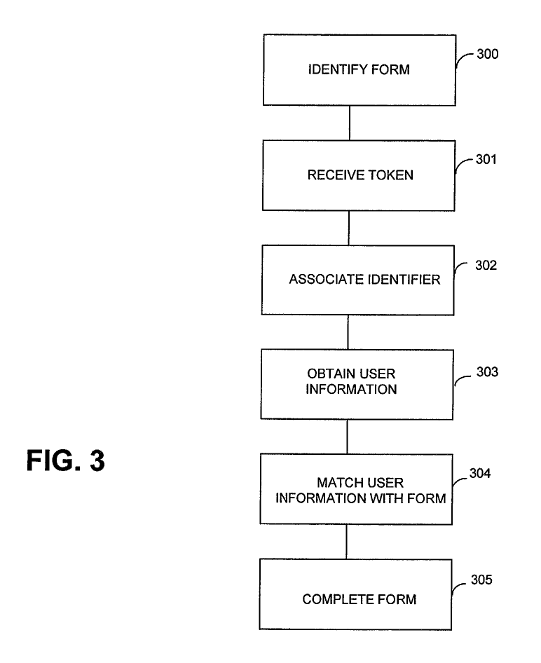

Referring to FIG. 3, a method for facilitating online transactions includes the step of identifying a form presented to a web site visitor (Step 300). An HTML form object is typically used to display boxes in which the user is intended to enter information. Once the user enters the appropriate information, the user takes an action, which is implemented by the browser as part of the HTML form object, to direct the web browser to submit the form with its contents to the merchant's web server. Typically, this is implemented by a button that can be clicked with a mouse, or by the user typing the “enter” key when the cursor is in the text box.

The client software is able to access elements of the web pages a user views on that computer. The client software does this by parsing the elements of the hypertext markup language (HTML) representation of the web page and determining whether or not elements that specify the presence of a text-input box are present. For instance, the client software, by parsing the HTML active in the user's browser, can notice that the active HTML page contains a form element requesting input. For example, the form might request a username and password, contact information, such as name, address, phone number, and email address, payment information, such as a user's credit card number and expiration date, or some combination of this personal data. In another embodiment, the author of the HTML based web page includes specific HTML coding, for example using <META> tags, that allow the client software to easily identify the information requested in the form.

The method also includes the step of receiving an identifier associated with a token presented by a user (Step 301). In one embodiment, this token is presented by the user for the purpose of completing the form identified by the client software. In one embodiment, the identifier is associated with an RFID token that contains a unique identifying serial number (often a 32 bit serial number) that serves as the unique identifier for the system. In another embodiment, the identifier is associated with a magnetic stripe card. The magnetic stripe swiped can be on a traditional credit card, debit card, bank card, loyalty card, rewards card, or some other kind of card or object with a magnetic stripe. The unique identifier can be the card's assigned number, or a unique identifier recorded on the card's magnetic stripe. The unique identifier can be a number generated by providing information read from the magnetic stripe together through a one-way hash algorithm. For example, the cardholder name, card number, and expiration date, are combined, and the combined result presented as input to a one-way function, resulting in a unique number that can be used as the identifier.

The method can also include the optional step (not shown) of a user providing a password or personal identification number (PIN). Such password or PIN can be used to authenticate the user to the system. In another embodiment, the password or PIN can be an authentication challenge associated with, and operational with, an existing payment network, for example, a PIN associated with a debit card network.

The method also includes the step of associating the identifier with a user (Step 302). When a user registers with the system, which typically occurs when the token is given to the user, or when the user first uses the token, a binding is made between the user and the token's unique identifier. During registration, a user profile (also referred to as a user profile) is created for the user either locally on the user's computer, on a remote database, or with some combination of local and remote storage. The unique identifier of the tag (or unique identifiers of multiple tags) the user registers is included in that user's user profile. From that point forward, when that unique identifier is presented to the system it can be associated with the user's user profile.

The method includes obtaining user information based on the identifier (Step 303). The user information in a user profile can be contained within a file or database local to the computer, or the information can also be stored in databases accessible across a public network, such as the Internet. The user information can also be accessible across a private networked system including databases accessible over corporate intranets, a proprietary corporate network, or a wide-area network. The user profile of a user can contain a variety of information, such as a user's name, address, phone number, email address, credit card numbers, and so on. In one embodiment, the information about a user is obtained from the profile, and sent back to the location from where the request for it originated. For example, to fill in a payment form included on a web page, the web page would need user information such as the name, address, and credit card number of the user. In one embodiment, all of the information within a user profile is returned to the requesting client software. In another embodiment, the client software requests, and only receives, certain specified elements of information from the user profile.

In cases where a payment method is desired, a user will often only have one payment method specified for use with the system. In cases where more than one payment method is registered in the system by a single user, one method can be identified as a “preferred” payment mechanism. The user may be given a choice at the time of certain transaction to choose a payment method, while at other times the preferred payment mechanism is used.

The method also includes matching the user information with the proper fields in the web page form (Step 304). The client software has the necessary user information to complete the form, and the client software enters the information in the appropriate form fields. In one embodiment, the client software does this with the aid of a field mapping script. A field mapping script is a set of instructions that describes which information elements should go into which text fields. For example, if a field in a web form has the name attribute “N1”, the field mapping script for that web page would indicate to the client software that the “N1” field corresponds to the user's first name.

In one embodiment, field mapping scripts are generated by a computer program, referred to as a site profiler, that automatically reviews web sites, and identifies forms used by the web site. The site profiler makes “best-guess” estimates of what the mappings should be. A (human) system operator can check the automatically generated field mapping scripts for errors, and make any necessary changes. In another embodiment, the field mapping scripts are generated by a person manually inspecting the web site and writing the scripts. In another embodiment, the system identifies changes in the field mapping script for a particular site based on changes made by the end-user (or multiple end-users). In another embodiment, field mapping scripts are generated by the client software. In another embodiment, field mapping scripts are generated by a computer on a network and the scripts are stored in a database accessible over the computer network. The scripts are accessible to the client software through a server, such that the client software can download an appropriate script when it is needed.

In another embodiment, field mapping scripts are not used, but rather, heuristic rules are used by the client software to determine the appropriate mappings of information into form fields. For instance, the client software can determine that a form with the name attribute “LastName” should be filled with the user's last name. In another embodiment, the client software first tries to find a field mapping script to fill a particular form, and if one does not exist, it uses heuristic rules to fill the form. In another embodiment, the client software is able to recognize web forms that follow the electronic commerce markup language (ECML) guidelines. In another embodiment, the client software is able to recognize web based form elements based on elements included in the HTML of a web page that follow a specification set forth that the client software can recognize.

The method also includes the step of completing the form (Step 305). The matched information is provided to the network application to complete the form. In one embodiment, after completing the form, the client software lets the user submit the information. This allows the user to check that the system filled in the appropriate forms with the appropriate information. In another embodiment, the client software, after filling in the forms, directs the browser to automatically submit the form without opportunity for user intervention. The submission of the completed form results in an action determined by the merchant website. In one example, the user is logged into a site. In another example, payment information is submitted for an item to be purchased. In another example, membership information is submitted, and so on.

The steps associated with this method can be performed in a different order than just described. For example, in one embodiment, the steps of identifying the form (Step 300) and receiving the token (Step 301) can occur in opposite order, such that the presentation of the token is the first step of the process. Likewise, other steps can be performed before or after other steps.

In one embodiment, the method steps are performed in response to a single user action, where the single user action is the presentation of the token to the reader. In one embodiment the single user action is the waving of an RFID token proximate to a RFID reader, in another embodiment the single user action is the moving of a magnetic stripe card through a magnetic card reader. In either case, the user is, through this single action, able to initiate the online action or transaction. This method, simply initiated with a single action, allows a user to fill in a form on the web, for example, and have the form submitted to the merchant web server.

In one embodiment, a token can be set to be used a certain number of times. Each time the token is used, the system registers its use, and renders it inactive after that number of uses. This function can act like a debit card. In this example, a person can pre-pay for 10 purchases of a specific item from a merchant. Once the customer uses the token 10 times, to buy 10 items, the token will be rendered inactive. In this embodiment, executing payment includes obtaining a count value associated with the token, and if the count value is greater than zero, decrementing the count value.

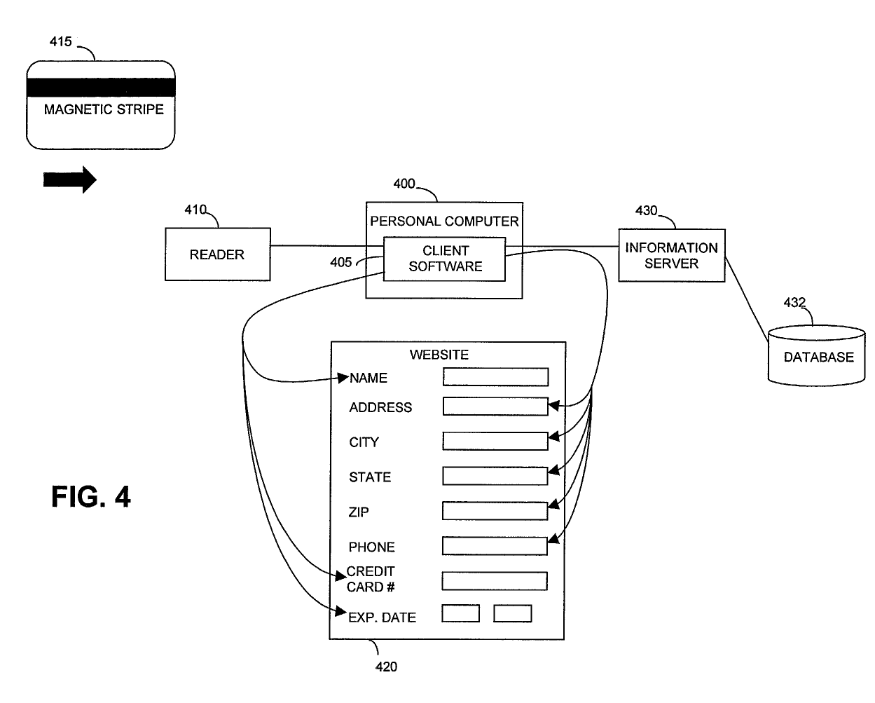

Referring to FIG. 4, in one embodiment, the computer 400 receives from the reader 410 the information stored on the magnetic stripe card 415 and uses the information from the card directly (without profile look-up) to fill out an online form 420. The information is read from the card 415, and the information present on the card is used to complete an on-line form, without access to an information server 430, and without having the information stored locally on computer 400.

In another embodiment, the computer 400 receives from the reader 410 information from the magnetic stripe card 415, and completes as much of a form 420 as it can with the information contained on the card 415. In addition, the system derives a unique identifier associated with the card 415, for example using the one-way function as described above, and uses it the unique identifier to obtain the remaining information needed from the user profile associated with the unique identifier. For example, if this magnetic stripe is on a credit card, the card will contain information about a person's name, credit card number, and card expiration date. This information is entered by the client software 405 on the user's computer 400 to the forms in the user's browser 420. The user's name and credit card information does not have to be on the server 430 or database 432. However, when the card information is received by the client software 405, in addition to using the information to complete the form, it uses the data, in some combination, as the input to a one-way function to obtain a unique identifier. This identifier is used to look up a user profile by server 430 in database 432. For example, the user's shipping address and telephone number may be stored in the user's user profile and can be retrieved through the unique identifier. However, the user's name, credit card number, and credit card expiration date is provided directly from the magnetic stripe of the card 415. In this way, the security of the user's credit card information is improved, because it does not have to be stored in database 432, and so the credit card information will not be susceptible to interception en-route to the server 430, or when stored on server 430. The user's privacy is improved because someone with access to the server 430 does not have the user's credit card information, which might be used to find out other information about the user. The system can thus provide user identification and information services without knowledge of the user's name or credit card information.

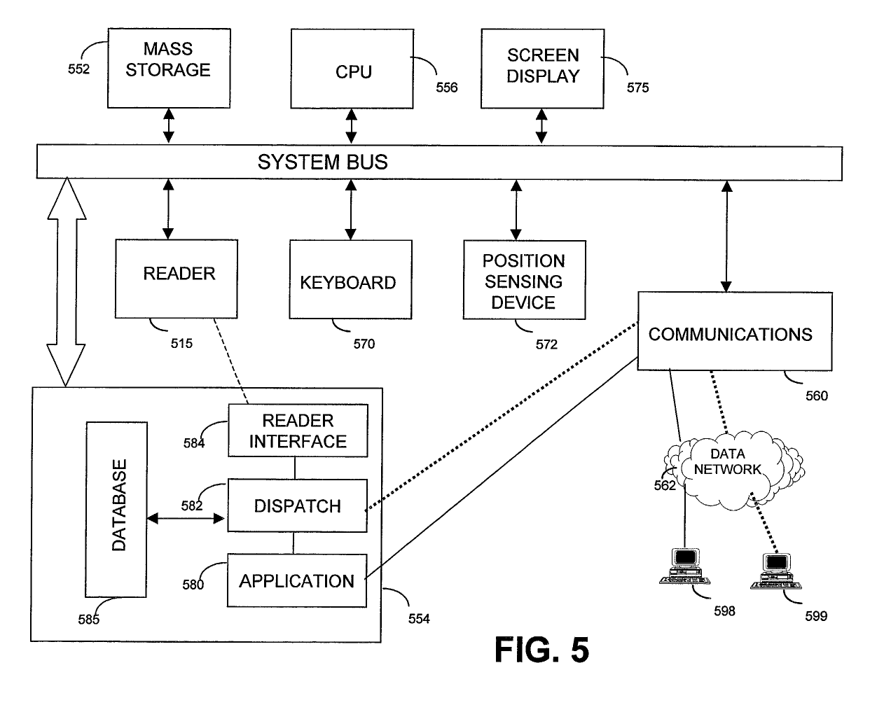

Referring to FIG. 5, in one embodiment, a computer includes a CPU 556, RAM and ROM memory 554, a screen display 575, mass storage 552 such as a hard disk, a keyboard 570 and a position sensing device 572 such as a mouse. The computer is also connected to a reader 515, such as the RFID reader or magnetic stripe reader described above.

Computer software is stored in RAM memory 554 includes reader interface software 584 for communicating with the reader 515 and local and remote databases. The reader interface 584 determines whether signals received from reader 515 in fact indicate the presence of a token. The reader interface 584 checks data generated by the reader 515 for proper format and parity, thus eliminating spurious signals due to noise. The dispatch module 582 responds to the presence of signals received from the reader interface 584. In one embodiment, the signals received from the reader interface 584 include a token identifier. In another embodiment, the signals received from the reader interface 584 include the type of token associated with the identifier, and the software version of the reader 515. Other information can be stored on the token besides the identifier, and in another embodiment, that information is communicated by the reader interface 584 to the dispatch module 582.

In the embodiment of FIG. 5, the dispatch module 582 obtains personal user profile information in response to the identifier from another computer 599 that is connected to the network 562. In one embodiment, the dispatch module 582 sends a request to the computer 599 that can include the identifier and other information. Such other information can include another unique identifier associated with the reader. The reader identifier, if included in the request, can be used to identify the source of the request (for authentication) or to limit or filter the user profile information that is to be returned. The computer 599 responds with some or all of the profile information, and possibly other information. Based on the information communicated from the computer 599 to the dispatch module 582, the dispatch module 582 communicates with the software application 580.

The embodiment of FIG. 5 has the advantage of not requiring the database 585 on the computer to be kept up to date as new tokens (with new identifiers) are introduced, because the identifier/access criterion matching is performed by the computer 599. In one embodiment, a local database 585 is used to store identifiers, access criteria and other related information. In one embodiment, the database 585 acts as a cache to store temporarily the information and associated access criteria. In another embodiment, the database 585 is also stored on mass storage 552 so that the database 585 accumulates and stores each identifier/access criteria once it is determined.

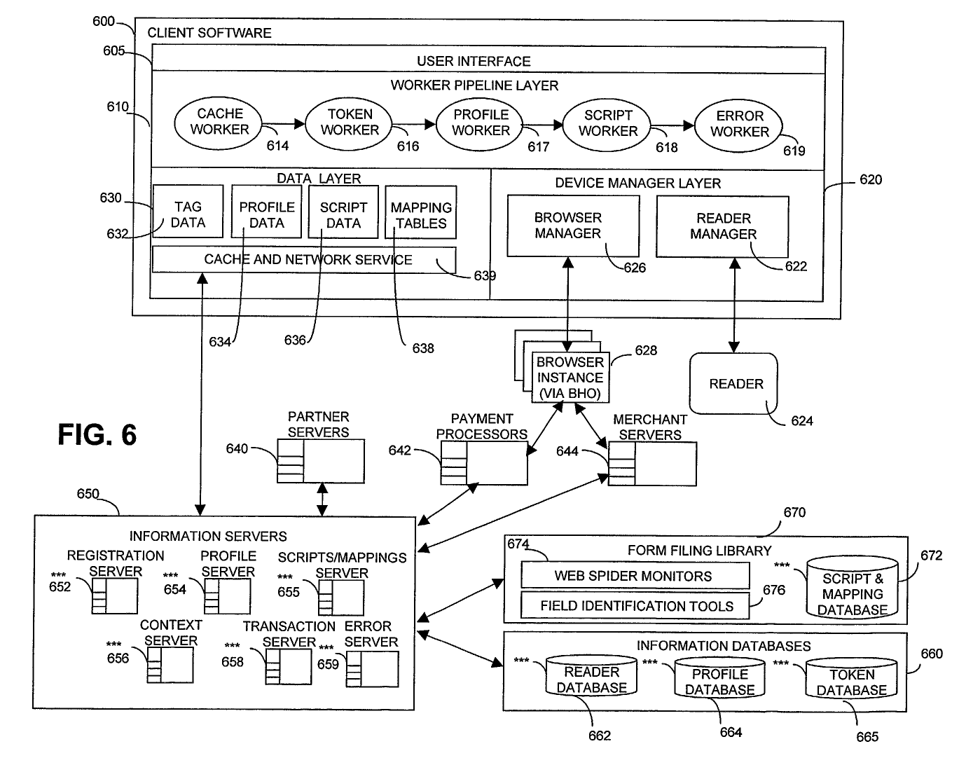

Referring to FIG. 6, a personal computer used to complete a form or identify a user who is accessing a web page includes an operating system and various network applications (for example, a web browser 628) that allow the computer to access the Internet.

The computer includes client software 600 that coordinates token-related events. It processes token events that occur at the reader 624, formulates queries to the appropriate information servers 650 to obtain customer information to complete transactions, and controls the user interface to the system for the user. The client software 600 has been implemented with four distinct functional layers, a user interface layer 605, a worker pipeline layer 610, a device manager layer 620, and a data layer 630. Each of the layers include various software components that coordinate operations on those four functional areas.

The user interface layer 605 formats and presents information to the user of the software. The user interface for the client software 600 includes a control panel for configuring the software, dialog boxes that alert the user to actions of the program, and error dialogs that display error states to the user. The user interface layer 605 also provides an interface for new user registration and new token registration.

The worker pipeline layer 610 performs operations on token data and customer data on the computer. The worker pipeline layer 610 is structured as a queue of software components, also referred to as “workers,” that process software events in a sequential manner, referred to as a “pipeline.” The worker pipeline controls caching 614, token identification 616, personal data manipulation 617, form script mapping 618, and error handling 619.

The cache worker 614 is a module that monitors events and passes notifications of events to a data layer 630. The cache worker 614, through the browser manager 626, is the part of the client that identifies that a user is on a web page with form fields. By providing the data layer 630 with notifications of browser manager 626 events, the cache worker 614 allows the data layer 630 to pre-fetch information from over the network, improving system responsiveness to token presentation and other information-intensive events. For instance, if the user is on a web site, and the client software 600 does not have the field mapping script for that site, the cache worker can alert the data layer 630 to the absence of the script. The data layer 630 can then attempt to obtain the appropriate script for that site before the user takes any action.

The token worker 616 handles token-related events, such as tag presentation or card swipe and receives the resulting data. The token worker 616 performs operations on the information that results from tag and swipe events that make the data from those events meaningful to other components of the software. For instance, the token worker might take in the elements of data from a credit card swipe and generate a unique identifier from them. The token worker also initiates the data lookup with the data layer 630 to associate the identifier with the proper user information profile.

The profile worker 617 is a module that receives user data from a profile (returned either from the local cache 634 or from the profile server 654) and formats the information for use by the script worker 618, or other components of the client software 600. If any elements of the user data are incomplete or out-of-date, the profile worker 617 tries various options to make sure it has the most complete set of information possible.

The script worker 618 is the code that executes the form-filling scripts. This worker actually performs the form-filling, with communications help from the browser manager 626. That is, this worker 618 matches the user information with the correct field mapping script. Then, the worker 618 also completes the form by entering the information into the browser 628, through the browser manager 626.

The error worker 619 is a module that handles error states, and provides notifications to the user interface layer when error states occur.

The device manager layer 620 of the client software 600 is a software component that controls and organizes the specialized device managers, such as the browser manager 626 and reader manager 622. Since the managers in the device manager layer 620 provide many useful functions for communications control, they are used for many purposes within the system, including communications with the reader 622 and network applications (browser manager 626).

The browser manager 626 controls and organizes communications between the client software 600 and the network applications 628. It is enabled with various methods to communicate with different network applications instances 628. In one embodiment, the instance 628 is an INTERNET EXPLORER browser, and the browser manager 626 uses a browser helper object (BHO) to obtain information from, and pass information to, the browser.

The Browser Helper Object (BHO) is an add-on piece of software provided to work with INTERNET EXPLORER. When the client software is installed, the BHO is registered with the browser Internet Explorer 628 and executes whenever an instance of INTERNET EXPLORER launches. The BHO is therefore available to communicate with the software system via the browser manager (626) during all web-site sessions. No additional changes to the browser are required.

Internet Explorer 628 notifies the BHO of any web event occurring in the Browser. Examples of these events are navigation to a new web page, completion of downloading a web page, or pressing a submit button. The BHO also can access internal data structures of INTERNET EXPLORER, including web forms being displayed and the plain HTML of the current web page. In addition to receiving notifications of web events and accessing browser data structures, the BHO also implements a communications interface to the browser manager 626. The BHO passes notifications of all web events to the browser manager 626, where the events can be fed into the processing pipeline for action by the workers. The browser manager 626 also uses the communications interface to allow workers to send instructions to the BHO to modify browser data structures. An example of this would be for the script worker 618 to notify the BHO to fill a specific field on a web form, or navigate to a different web page.

The reader manager 622 is a device manager that controls, organizes, and accepts information from the one or more readers 624 (shown as one reader in the figure) connected to the computer. The reader 624 is the hardware interface with a RFID tag or a magnetic stripe card. Typically, the reader manager 622 exchanges information with the token worker 616.

The data layer 630 is the centralized point of contact for information requests from other client components. By centralizing requests for information, the amount of code required to connect the client software 600 to one of the servers 650 is reduced. The data layer 630 also assists with implementing encryption and pre-fetching of data such as field mapping scripts. The data layer 630 also serves as the local data cache the client software 600 can draw from. Tag Data 632, Profile Data 634, and Script Data 636 can be held locally by the software in this layer.

A function of the data layer 630 called the Cache and Network Service 639 communicates with servers 650 over a network. In one implementation, data passed between the Network Service module 639 and the servers 650 is passed using a form of extensible markup language, or XML.

In one embodiment, client software 600/server 650 data communication is achieved through an XML based protocol called the Simple Object Access Protocol, or SOAP. SOAP is a lightweight protocol for exchange of information in a decentralized, distributed environment. SOAP messages consist of three parts: an envelope that defines a framework for describing what is in a message and how to process it, a set of encoding rules for expressing instances of application-defined data types, and a convention for representing remote procedure calls and responses. SOAP messages can be, and in this case are, carried in hypertext transfer protocol (HTTP) messages.

The client 600 communicates with information servers 650 to acquire data on customers and take necessary actions. The information servers 650 are a group of one or more servers and databases that take input from the client software 600 and return requested information back to the client software 600. For instance, the client software 600 can send to the servers 650 a unique identifier and a reader 624 location. The servers 650 will process the information and return the appropriate user profile information in response. The information servers 650 can also communicate with third party servers such as payment processors 642, partner servers 640, and merchant servers 644. The information servers 650 shown have various functions.

An error server 659 receives error state notifications from client software 600. Most error state notifications are reports of network faults. The error server is separate from the other servers to prevent a load spike from an error at a malfunctioning destination from “flooding” the rest of the system with requests.

A context server 656 coordinates responses of the system based on locations of the request. The location of the request can be determined, for example, by the internet protocol (IP) address of a requesting system, or by a reader identifier associated with the request. The information sent back to the client software 600 can vary based on location, time, sequence of events, and so on, in other words, based on the context of the request.

A profile server 654 coordinates the network storage and retrieval for profile data. Since this server's responses change based on client interaction, this is a dynamic server. Therefore, the profile server 654 is implemented with a full database back-end, such as an Oracle, SQL Server 2000, or Postgresql database.

A registration server 652 provides the mappings between tokens and users, and ensures all system identifiers are unique. This server also plays a role in pre-registration of tokens for use in the system.

A transaction server 658 communicates with payment processors and specializes in the handling of sensitive financial data. For instances where the authorization or clearance of financial transactions occurs from the server side of the system, this server is employed.

A scripts/mapping server 655 provides client software 600 with site specific field mapping scripts to be used in form-filling. Each script has a unique identifier, which is often a reference to a particular uniform resource locator (URL).

The servers 650 draw information from databases 660. Reader database 662 contains information about the population of readers 624. Profile database 664 contains personal information on each user of the system. Token database 665 contains information about the population of tokens deployed. This includes information on both RFID tags and magnetic stripe cards.

Form Filling Library 670 contains the site specific field mapping scripts in a script/mapping database 672, accessible through the script/mappings server 655. The library 670 generates these scripts through field identification tools 676. These tools 676 take as input a URL, or reference to a web page with a form. The tools 676 examine the HTML of the forms on a web page and generate a field mapping script for the site. This script is then checked for error, possibly by a human, and any necessary changes to the automatically generated script are made. Web spider monitors 674 consistently poll various websites to see if the forms on their pages have changed. If the monitors 674 report a change in a form, the field identification tools 676 regenerate the script for that site.

Through the same XML/SOAP protocol used to talk to the client software 600, the information servers 650 can share information with payment processors 642, partner servers 640, and merchant servers 644. Payment processors 642 are third party processors of payment transactions. These are, for example, merchant banks that can authorize, settle, and clear credit card, debit, and other financial transactions. Payment processors 642 can also include other payment transaction processing networks outside of the credit and debit systems, such as PAYPAL from X.com. Partner servers 640 are servers in partner organizations that provide data for transaction processing, loyalty/rewards tracking, coupon or discount giving, or report submission. Merchant servers 644 are information servers operated by the retail merchant. These can be used in running both retail operations and web site operations. The system is designed such that the information servers 650 can share information directly with merchant servers 644 to streamline inventory, reporting, user registration, and so on.

The networked architecture of this system allows the same payment object to perform different functions depending on location and context. Context-dependant action is primarily enabled by identifying the reader location. For example, the same identifying token that identifies a person to a personal computer can be used at a retail location, or with different merchants. For instance, in one implementation, the same token used in form filling online can be used in an airport check-in system to pass the appropriate customer information to the airline check-in staff, or airline check-in system.

In another example, Frequent Flyer cards, enabled with an unique identifier such as a magnetic stripe or RFID tag, can allow instant account access and online ticket ordering at home and immediate check-in at the airport. The system can determine whether the person is using the system from their home or from the airport based on information passed in the request. In each context-dependent case, the system architecture remains similar, with slight variations to account for the workflow of a device. For instance, a retail store might keep a mirror copy of elements of the profile database that are critical for quick-turnaround performance. A coffee shop, for instance, might keep preference information about loyal customers that live in the area on a database local to the shop that can be updated on a regular schedule from the online profile database.

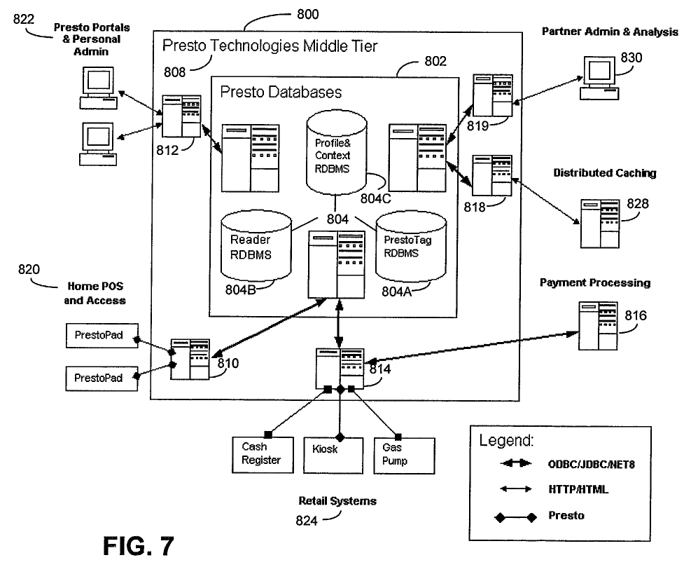

Referring to FIG. 7, in one embodiment, a server and networked database system 800 act as the backbone to a tag-enabled system, such as the system described above. The server maps identifying information from each tagged object to targeted response information. The result can be, as described above, user profile information used for filling an online form.

In one embodiment, the networked database system 800 includes relational databases 804A, 804B, 804C (generally 804) that store information about the deployed tags, readers, the user community and the merchant community. In one implementation, common open products are used for the primary databases 804, so the system uses standardized SQL as the query language. The system thus leverages state-of-the-art database techniques independent of particular hardware or software vendors, to easily integrate advances in database technology, and to enjoy enhanced interoperability with partner organizations.

Surrounding the database core 802 in one embodiment are middleware gateways 808 which handle requests from the outside, restricting access to only the data that is appropriate for the channel and site. The middleware gateways 808 also perform the protocol conversions necessary for interoperating with the outside devices, and runs heuristics for forming meaningful responses to queries. In one embodiment, the middleware gateways 808 make use of secure encryption technology. Specifically, SSL protocol is used to protect all network activity.

In one embodiment, the middleware gateways 808 include home point of sale (POS) and home access gateway 810. Players or readers in the home 820 access the system through this gateway 810. The gateway 810 relays the request into the core 802, and formulates a response to the home system that mediates the client's next action. The data passed between the client running on the home machine and the home gateway 810 is not visible to the consumer and employs a protocol optimized for maximum efficiency and scalability.

In one embodiment, the middleware gateways 808 include a personal administration portal gateway 812. The system generates personal portal-like pages on Internet-accessible, or system accessible, terminals 822 from this knowledge base. Through the personal portal 812, the system provides to a user administrative control over the information that is on file about the user and how it may be used.

In one embodiment, the middleware gateways 808 include a retail integration gateway 814 for integration into relevant retail systems of customers. Retail systems 824 such as point of sale terminals, kiosks, and other connection points access the databases through this gateway 814. In another embodiment, the middleware gateways 808 include a payment processing gateway 816, which interacts with the retail integration gateway 814, and provides an interface to third-party transaction clearing houses through this gateway 816. The payment processing gateway 816 can also interact with the Home POS and Access gateway 810.

In one embodiment, the middleware gateways 808 include a distributed caching gateway 818. For some applications and installations, it is necessary to cache content on a computer, server, or other storage medium 828 close to the user. This increases reliability and ensures smooth operation of certain business segments.

In one embodiment, the middleware gateways 808 include a partner administration and access gateway 819. Through this gateway 819, partners who distribute tokens and readers receive reports on their customers' usage and actions, and control the behavior of the systems they have deployed through their own control system 830.

In another embodiment, the middleware gateways 808 include a gateway for integrating physical access control systems (not shown). RFID technology is pervasively used for building access control and garage access control. This gateway acts as an interface to legacy systems and newly deployed systems for such physical access control systems.

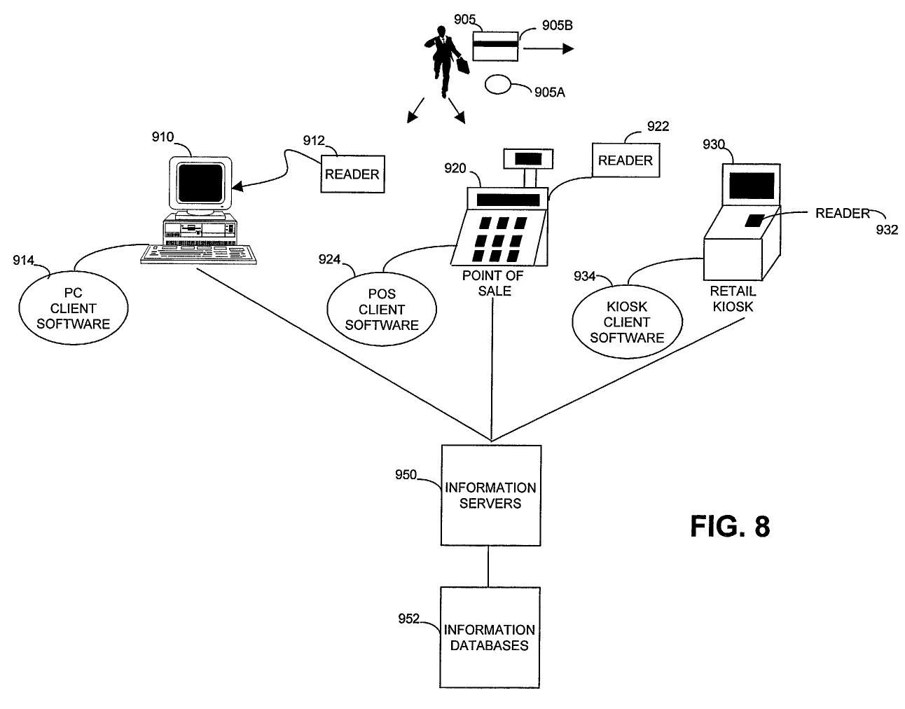

Referring to FIG. 8, in one embodiment, the system described can work in a variety of different locations and circumstances. In this diagram, computer 910, reader 912, PC client software 914, information servers 950, and information databases 952 respond as described above to the presentation of tokens 905. In addition, a point of sale (POS) device 920 equipped with reader 922 and POS client software 924 can receive unique identifiers from tokens 905 as well. In addition, a retail kiosk 930 equipped with reader 932 and kiosk client software 934 can receive unique identifiers from tokens 905 as well. Both of these systems can receive user data from databases 952 through information servers 950. The client software on each device is essentially the same, but with modifications made to meet the needs of that particular device, and the workflow of the particular applications that device serves. For instance, in the case of POS device 920, the presentation of a token 905 can result in the ordering and payment for a retail item of sale, such as a pre-specified order of coffee at a coffee shop. In the case of retail kiosk 930, the presentation of token 930 might cause the user to be logged into the web site of the company owning and operating the kiosk 930. The user could then make purchases on, or find personalized information on, the kiosk 932. Both of these processes would use information from the same user profile held in database 952, accessible through the presentation of token 905.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. A computer-based method for completing a form presented to a user in a computer application program, the form requesting information about the user, the method comprising the steps of:
(a) identifying a form presented to a user in a computer application program, the form requesting information about the user;
(b) receiving a magnetic stripe card comprising card information;
(c) generating a unique identifier based on the card information;
(d) associating the unique identifier with the user;
(e) obtaining user information based on the identifier;
(f) matching elements of user information with elements of information about the user requested in the form; and
(g) completing the form request for information with the matching elements of user information.

2. The method of claim 1, wherein the steps are performed in response to a single user action, the single user action comprising directing a magnetic stripe card through a magnetic stripe reader.

3. The method of claim 1, wherein the form is identified by parsing the HTML code of a web page.

4. The method of claim 1, wherein the magnetic stripe card is received by a reader comprising a magnetic stripe card reader and an RFID token reader.

5. The method of claim 1 wherein the unique identifier is generated by providing the card information as input to a one-way function.

6. The method of claim 5 wherein the unique identifier is generated by combining elements of card information, and providing the combined card information as input to a one-way function.

7. The method of claim 1 wherein the user information is at least a portion of a user profile obtained from a server accessible via the internet.

8. The method of claim 1 wherein the user information is obtained from a local database.

9. The method of claim 1 wherein elements of user information are matched with elements of information about the user requested in the form by using a field mapping script.

10. The method of claim 1 wherein step (g) comprises completing the request for information with at least one element of card information and with matching elements of user information.

11. The method of claim 1 wherein elements of user information are matched with elements of information about the user requested in the form by matching form field names with elements of user information.

12. The method of claim 1 wherein:
step (a) further comprises identifying a form in a web page downloaded from a merchant web server presented to a user in a web browser;
step (b) further comprises associating by an information server separate from the merchant web server the unique identifier with the user;
step (d) further comprises obtaining by the merchant web server directly from the information server user information based on the identifier; and
step (g) further comprises completing by the merchant web server the form request by matching elements of user information with the requested information.

13. A computer-based method for completing a form presented to a user in a computer application program, the form requesting information about the user, the method comprising the steps of:
(a) identifying a form presented to a user in a computer application program, the form requesting information about the user;
(b) receiving a magnetic stripe card comprising a unique identifier;
(c) associating the unique identifier with the user;
(d) obtaining user information based on the identifier;
(e) matching elements of user information with elements of information about the user requested in the form; and
(f) completing the form request for information with the matching elements of user information.

14. A computer-based method for completing a form presented to a user in a computer application program, the form requesting information about the user, the method comprising the steps of:
(a) identifying a form presented to a user in a computer application program, the form requesting information about the user;
(b) receiving an RFID tag comprising a unique identifier;
(c) associating the identifier with the user;
(d) obtaining user information based on the identifier;
(e) matching elements of user information with elements of information about the user requested in the form; and
(f) completing the form request for information with the matching elements of user information.

15. The method of claim 14 wherein the steps are performed in response to a single user action, the single user action comprising providing a RFID token to a reader.

16. The method of claim 14 wherein the form is identified by parsing the HTML code of a web page.

17. The method of claim 14 wherein the magnetic stripe card is received by a reader comprising a magnetic stripe card reader and an RFID token reader.

18. The method of claim 14 wherein the user information is at least a portion of a user profile obtained from a server accessible via the internet.

19. The method of claim 14 wherein the user information is obtained from a local database.

20. The method of claim 14 wherein elements of user information are matched with elements of information about the user requested in the form by using a field mapping script.

21. The method of claim 14 wherein elements of user information are matched with elements of information about the user requested in the form by matching form field names with elements of user information.

22. The method of claim 14 wherein:
step (a) further comprises identifying a form in a web page downloaded from a merchant web server presented to a user in a web browser;
step (c) further comprises associating by an information server separate from the merchant web server the unique identifier with the user;
step (d) further comprises obtaining by the merchant web server directly from the information server user information based on the identifier; and
step (e) further comprises matching by the merchant web server elements of user information with elements of information about the user requested in the form
step (f) further comprises completing by the merchant web server the form request for information without user completion of the form.

23. A system for completing a form presented to a user in a computer application program, the form requesting information about the user, the system comprising:
a display for displaying a form presented to a user of a computer application program, the form requesting information about the user;
a token reader for receiving a token presented by the customer, the token comprising at least one token of a magnetic stripe card and an RFID tag;
a dispatch module for associating the identifier with the user, obtaining user information based on the identifier, matching elements of user information with elements of information about the user requested in the form, and completing the form request for information with the matching elements of user information.
